(19) United States
(12) Patent Application Publication
(10) Pub. No.: US 2003/0014919 A1
(43) Pub. Date: Jan. 23, 2003

(54) Seismic sensor controlled door unlocking system

(76) Inventor: William Diaz-Lopez, St. Just, PR (US)

Correspondence Address: NILS H. LJUNGMAN, NILS H. LJUNGMAN & ASSOCIATES, P.O. BOX 130, GREENSBURG, PA, 15601-0130, US

(21) Appl. No.: 10/078,607

(22) Filed: Feb. 19, 2002

Related U.S. Application Data
(63) Continuation of application No. 09/048,906, filed on Mar. 26, 1998.

(51) Int. Cl. E05F 15/20

(52) U.S. Cl. 49/31

(57) ABSTRACT

A seismic sensor controlled door unlocking system which has a vibration sensor and a control system. The vibration sensor is configured to detect heavy vibrations such as those made by an earthquake. The control system maintains the locked state of, and has the ability to unlock, a door to which it is connected. Upon detection of a large vibration by the vibration sensor, the control system unlocks the door.

### FIELD OF THE INVENTION

This invention relates to a vibration sensor for detecting vibrations resulting from an earthquake, a bomb explosion or other vibration inducing disasters, and a control system connected to the vibration sensor which can cause a locked door to be unlocked when the sensor detects heavy vibrations from, for example, an earthquake. The vibration sensor is an inexpensive device which can be manufactured with standard off-the-shelf parts for simplicity, and comprises mostly mechanical parts (as opposed to electrical parts) to ensure dependability and long life of the vibration sensor. The vibration sensor is also housed in a control box which contains a backup battery, door lock control circuitry and a power regulator.

### BACKGROUND OF THE INVENTION

Vibration sensors such as seismic detectors are well known. These devices are used to detect vibrations from an earthquake, and produce an electrical signal indicative of the seismic activity detected over a period of time. These types of devices only record a time period of the event, and do not produce a control signal to a further device such as a fluid valve. Also, these devices are very accurate, and as such are very expensive.

U.S. Pat. No. 3,359,538 to Raphael shows a pendulum type seismograph having a suspension cable 6 connected at one end to a pendulum 5, and a driving magnet 9 fixed to a base below the swinging pendulum. Movement of the pendulum about the coil around the magnet causes a current to develop in the coil 19, which is then recorded on a voltmeter 22. The seismic detector of Raphael is used only to record the seismic events.

U.S. Pat. No. 3,813,505 to Shoji shows a sensing device of acceleration and vibration which uses a seismic detector connected to an operating system for actuating a valve, cock or a switch in order to avoid a danger. The actuating device can open or close a valve in a gas line in order to prevent the flow of gas in a pipe that could be damaged by an earthquake. Broken gas lines have been known to cause great fires just after an earthquake.

U.S. Pat. No. 4,012,611 issued to Petersen shows a seismic switch for a door alarm, the switch includes a permanent magnet supported by a swinging pendulum. A magnetic reed switch is positioned below the magnet and produces an open circuit in the reed switch. When the magnet is displaced, the reed switch is closed, forming a closed electrical circuit. The closed electrical circuit is used to activate an alarm.

U.S. Pat. No. 5,694,867 issued to Diaz-Lopez (herein incorporated by reference) shows a security door system used in a bank, where the system includes two locking doors separated by an access chamber in which a metal detector is locked. The second door is usually locked to prevent a person from entering the bank. The second door is only unlocked when the metal detector detects no metal object such as a gun, and when the first door is locked. A power supply box includes an uninterrupted power supply and the control circuitry that is used to control the security door system, and is to be mounted to a wall. In this patent, if an earthquake or an explosion (such as from a bomb) was to occur, people from the bank could not escape because the door or doors would be locked. Thus, people could be trapped in the building. A bank employee could activate an emergency switch that would over-ride the system and open all locked doors, but the system would not then be fully automatic. If the bank personnel was incapacitated because of the vibration producing event such as a massive bomb explosion or earthquake, that person may not be capable of activating the over-ride to unlock the door or doors. Some systems which use electromagnetic locks include a 30 second time delay which unlocks the lock 30 seconds after a person pushes on the door. The purpose of the delay is to notify authorities that the normally locked door is about to be opened. This 30 second delay system would produce much panic if an explosion was to occur and people tried to rush out the door. The extra 30 seconds could mean the difference between life and death.

Thus, there is a need in the prior art door locking systems for a device in which potentially damaging vibrations caused by an earthquake or explosion can be sensed, and a control system which will use the sensed vibrations to unlock a door for emergency escape of occupants.

### BRIEF SUMMARY OF THE INVENTION

It is an object of the present invention to provide for an inexpensive vibration sensor that does not need to be as accurate as the present technology would allow, but could be manufactured using simple, off-the-shelf parts such that an inexpensive vibration sensor could be produced so that use of a large number of the sensors would be economically feasible.

It is another object of the present invention to provide a vibration sensor that can be easily checked to determine if the sensor is functioning properly.

It is another object of the present invention to provide a vibration sensor that can be easily adjusted and accurately checked.

It is another object of the present invention to provide for a vibration sensor in communication with a normally locked door such that when a vibration induced event occurs (such as an earthquake or bomb explosion), the normally locked door is unlocked to allow escape through the door.

It is another object of the invention to provide for a compact power control box in which all the battery backup, control circuitry and seismic sensor is located. The control box can be mounted in a secure area of the building away from the doors to prevent tampering therewith, and the box and its contents are mounted to a rigid wall or column of the building in order to insulate the seismic sensor from non-threatening vibrations such as vibrations from the door system or from heavy trucks passing by.

The objects of the present invention are realized in that the vibration sensor is comprised of a pendulum having a magnet connected at a bottom end of the pendulum, a normally opened magnetic contact switch located in a fixed position near the bottom of the swinging magnet, and a relay switch located near the magnetic contact switch to maintain the contact in an opened position after the vibration inducing event has ceased. The vibration sensor is also connected to a locking control system for a door such that the normally locked door can be unlocked automatically when the vibration sensor detects a vibration above a specified level. The vibration sensor is mounted in a lock box along with the battery backup power supply, the voltage converter, the electrical circuitry, and the fuses. The box is secured to a rigid structure of the building at a location away from the doors to prevent tampering and insulate the seismic sensor from non-threatening vibrations. The vibration sensor is mounted in a hollow metal box which is closed on both ends by plastic caps. A front face of the metal box has an opening and a glass plate covering the opening so that the pendulum can be viewed from outside. The pendulum includes a threaded weight can be adjusted along the pendulum. The weight has a marking thereon, and the inside of the box includes a scale in which the marking on the weight can be aligned in a plurality of positions in order to adjust the sensitivity of the pendulum. The vibration sensor includes a green LED and a red LED which is used to check if the sensor is functioning properly. In one embodiment, a relay switch is secured to a side of the metal box, while in another embodiment the relay forms the bottom cover for the metal box.

Other objects, features and advantages of the present invention will become apparent from a consideration of the following detailed description, and from the accompanying drawings.

### BRIEF DESCRIPTION OF THE DRAWINGS

FIG. 1 shows the vibration sensor.

FIG. 2 shows the vibration sensor in use with a door system.

FIG. 3 shows an electrical circuit with the vibration sensor and the relay switch connected to a magnetic lock.

FIG. 4 shows a control box in which the seismic sensor is placed therein, along with the battery backup and control circuitry.

FIG. 5 shows an electric circuit diagram for a seismic sensor used in a control system to lock a door.

FIG. 6 shows the seismic or vibration sensor with a glass window covering the front.

FIG. 7 shows the magnet and pendulum assembly of the vibration sensor.

FIG. 8 shows the seismic sensor with the adjustment scale, and the relay switch mounted on the side.

### DETAILED DESCRIPTION OF THE PREFERRED EMBODIMENTS

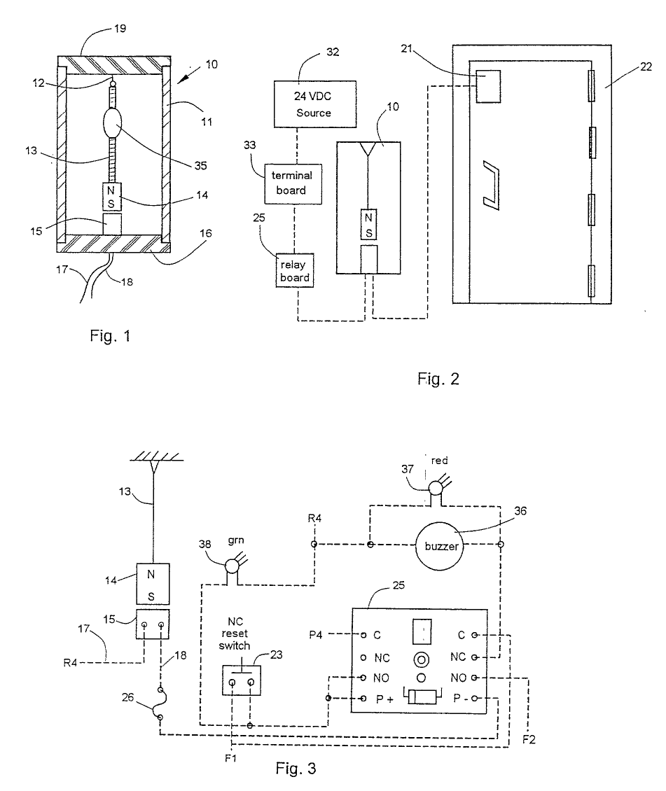

FIG. 1 shows the seismic or vibration sensor 10 formed of an aluminum box 11, a top plate 19 secured to the box 11, a pivot point 12 secured to the underside of the top plate 19, a threaded rod 13 is connected to the pivot point 12, a permanent magnet 14 is connected to the other end of the wire 13, a bottom plate 16 is mounted on the bottom end of the box 11, a normally opened magnetic contact 15 mounted on the bottom plate 16 so as to be near to the permanent magnet 14 but not in physical contact therewith, and wires 17 and 18 extending through a hole or holes in the bottom plate 16. The box 11 is preferably made of aluminum, but can be made of any material (I.e. metal or plastic) which would support the components. The top 19 and bottom 16 plates are made of a hard plastic material.

The wires 17 and 18 are connected to a relay board 25. The relay board 25 is a well known component, model number ASRB-1 made by Advanced Signaling Company of Arlington, Tex. The relay board 25 could also be RSBN- TTL ultra sensitive relay module of Advanced Electronic Technology of Brooklyn, N.Y. The normally opened (NO) magnetic contact switch 15 is used to detect for vibrations from an earthquake or bomb explosion. The magnetic contact 15 is a well known device made by ADI of Syosset, N.Y., having model number SR-1075/BR. The relay board 25 can also be one made by Advanced Signaling Company of Arlington, Tex., model number ASPR-1X5 relay board. The vibration sensor 10 is secured to a fixed location in which the vibration is to be monitored therefrom. If the vibration sensor is used to unlock a door in a bank building, the sensor could be mounted to a concrete wall or column of the building. A typical vibration level in which the vibration sensor would be set is about 0.1 or 0.2 gravities (or 0.2 g). A gravity of 1 g is equal to the weight of the object, and means that a force equal to the weight of the magnet would be required to displace the magnetic beyond the required distance to change the position of the magnetic contact switch 15.

In operation, when a vibration induced event such as an earthquake or a bomb explosion occurs above a specified seismic level, the magnet 14 starts to swing about the pivot point 12. When the magnet is displaced sideways beyond a specified distance, the contact switch opens and an electrical connection is broken between wires 17 and 18. The purpose of the relay board 25 is to maintain the electrical connection when the magnet 14 swings back over the contact switch 15.

FIG. 2 shows the vibration sensor 10 used in a normally locked door 22 of, for example, a building. The door uses a magnetic lock 21 or any other well known locking device that can automatically lock and unlock a door. Magnetic locks generally are operated on low voltages, such as 12 or 24 volts DC. A terminal board 33 such as the one produced by Securitron (model number CCS4-12 or CCS4-24) and the seismic relay board 25 supply and control the power to the magnetic lock 21. When a vibration inducing event, such as an earthquake, occurs, the power from a power source 32—which is used to activate the magnetic lock 21—is interrupted by the magnetic contact switch assembly 14 and 15, and the magnetic lock 21 is deactivated or unlocked so that the door can be opened for people to escape from the building.

FIG. 3 shows the vibration sensor used with the relay board 25. The magnetic contact switch 15 is connected to a ½ amp fast blow fuse 26. The fuse 26 will prevent the contact switch 15 from being welded closed if a short occurs in the electrical system. If the magnetic contact switch 15 is welded closed, then the system will not function as a vibration sensor. The fuse 26 is connected to the P(−) terminal of the relay switch 25. A buzzer 36 is also connected to the relay switch 25 and to a Normally Closed reset switch 23. Also connected in series with the buzzer 36 is a green light 38. When the green light 38 is on, the system is operating properly. A red light 37 is connected in parallel with the buzzer 36. The red light 37 can be mounted on the bottom portion of the vibration sensor 10 near the contact switch 15. When the red light 37 is on, the system is not functioning properly. Pushing the reset switch 23 will reset the system for proper operation if the contact switch 15 is operating properly (is not welded together).

Once the system is installed, it needs to be activated. With power connected, the normally closed reset switch 23 is pushed, providing power to the relay switch 25. This initial power energizes a coil (located between the P+ and P− terminals) in the relay switch which maintains an electrical connection from the power source 32 to the magnetic lock 21. Thus, the magnetic lock is activated or locked. When a vibration above a specified level occurs, such as when an earthquake or bomb explosion occurs, the magnet 14 in the vibration sensor 10 will be displaced beyond a specified distance, the contact switch 15 opens and an electrical connection between wires 17 and 18 is broken. When the contact switch 15 is open, power to the magnetic lock 21 is interrupted, and the magnetic lock 21 is released. When the vibration ceases, the relay switch 25 prevents power from being supplied to the magnetic lock 21 until the reset switch 23 is again depressed. Thus, the door 22 will not be re-locked when the vibration from the earthquake or explosion ceases or drops below the specified level to activate the vibration sensor 10.

A normally opened magnetic contact 15 is used to detect for vibrations from an earthquake or bomb explosion. The magnetic contact 15 is a well known device made by ADI of Syosset, N.Y., having model number SR-1075/BR. The magnet 14 is suspended by a threaded round bar 13 so that a vibration will displace the magnet. The pendulum bar 13 is threaded on its outer surface to allow a weight 35 to be positioned along the bar 13. The weight 35 has a hole passing through the axis, and is threaded to be engaged with the threads on the bar 13.

The purpose of the relay switch 25 is to prevent the power from re-supplying the magnetic locks after the vibrations have stopped. If a bomb was to explode, when the vibration ceases, it is not desirable to re-lock the magnetic locks because people will still need to exit the building. The sensitivity of the magnetic contact can be adjusted by displacing the magnet 14 from the contact 15, by using a heavier magnet, or adding moving the weight 35 along the bar 13. Changing the position of the weight 35 along the bar 13 will change the moment of the pendulum. This change will effect what force or vibration is required to displace the magnet 14 such that the reed switch 25 is changed from its normal position,

The vibration sensor 10 (or seismic detector) is preferably sealed within a metal box 11 as shown in FIG. 1. The top 19 and bottom 16 of the sensor 10 is made of plastic, but could be made of other materials such as metals.

The vibration sensor 10 could also be an off-the-shelf type seismic detector, but this is a costly instrument. The preferred embodiment uses the vibration sensor 10 because of its simplicity and low cost of obtaining off-the-shelf parts.

Other uses of the vibration sensor 10 could be for controlling valves in gas lines. The closed contact on the relay switch 25 could be connected to a motor which shuts gas valve when the quake occurs.

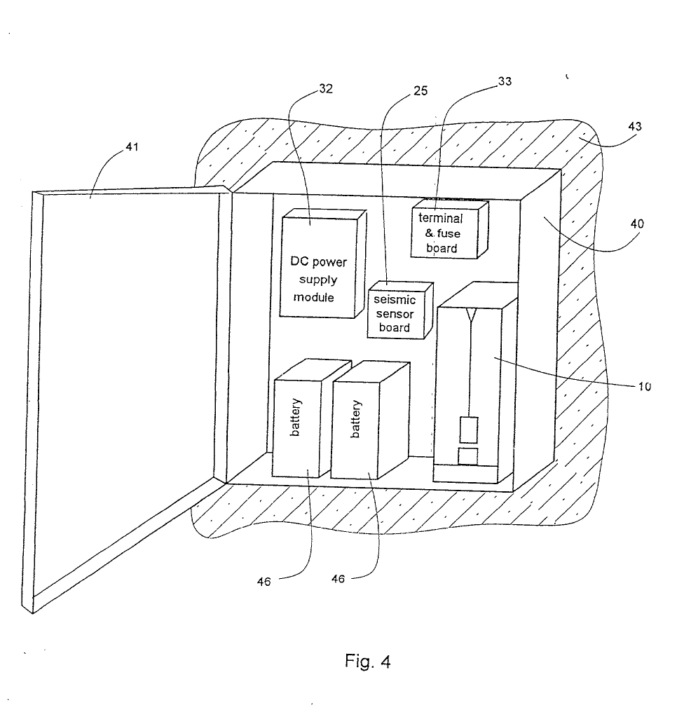

FIG. 4 shows a regulated power supply box 40 which is used to supply power to a magnetic lock system. Inside the box is stored a regulated DC power supply module 32, a terminal and fuse board 33, a seismic sensor board 25, 12 volt or 24 volt backup batteries 46, and the seismic or vibration sensor 10. The box 40 has a door 41 which can be locked to prevent unauthorized entry. The reset switch 23 and the green light 38 are preferably mounted on the door 41 so that they are accessible from the front of the door 41. An outside power source such as the 110 volts AC from the main power lines is connected to the DC power supply module 32, which reduces the voltage to 12 or 24 volts DC for use with the door system. If the main power is lost, the backup batteries 46 supply the power needed to control the door 22.

Placing the seismic sensor 10 inside the regulated power supply box 40 provides several benefits. One is that the seismic sensor 10 can be placed close to the circuitry in which the seismic sensor 10 is to have an effect when an earthquake or the like occurs. The box 40 is also to be mounted to a rigid wall or column 43 of the building so that the box and its contents are far away from the door system in order to prevent tampering. Placing the seismic sensor 10 in the box 40 also prevents unauthorized access or tampering with the seismic sensor 10. Also, the seismic sensor 10 will not be effected by non-threatening vibrations such as movement from the door or a passing vehicle if the box 40 is secured to a rigid structure.

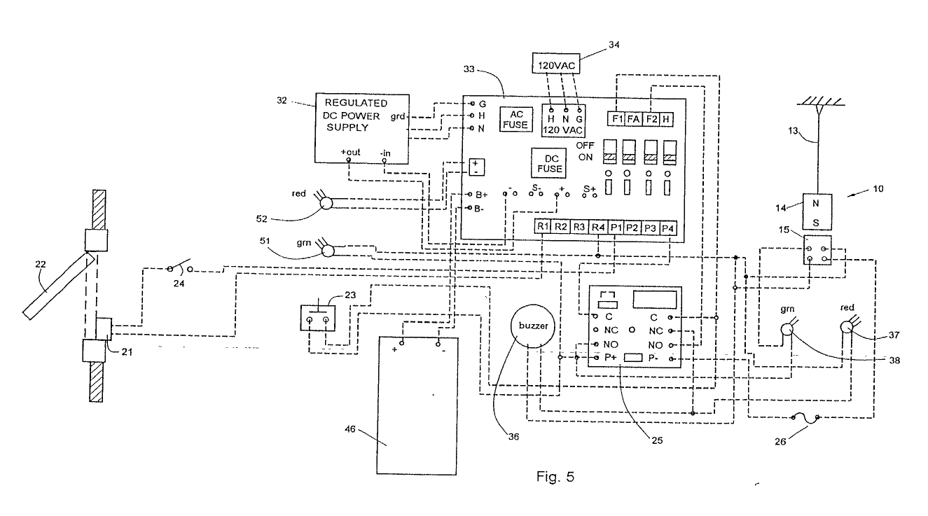

The vibration sensor 10 is shown in FIG. 5 in a system used to control a door lock. A door 22 is secured in a structure, and a magnetic lock 21 is associated with the door 22. A fuses and connector panel 33 (serial number CCS-4 made by Securitron Magnalock Corporation of Sparks, Nev.) is electrically connected to the backup battery pack or packs 46. The battery pack 46, the fuses and connectors panel 33, the relay switch 25, the reset switch 23 and the vibration sensor 10 are all contained within a control box for safe storage. A 120 VAC source 34 supplies power to the fuses and connector panel 33. A 12 or 24 volt DC power source 32 used to convert 110 volt AC to 24 volt DC is connected to a reset switch 23 and to the relay switch 25. One terminal of the magnetic contact 15 of the vibration sensor 10 is connected to the R4 terminal of the fuses and connector panel 33, while the other terminal from 15 is connected to the relay switch 25. In the embodiment shown in FIG. 5, the magnetic contact switch 15 is a double pole single throw contact. The second contact points are used for a second light to indicate the status of the contact switch 15. A ½ amp fast blow fuse 26 is used in this wire. When the vibration sensor 10 detects an earthquake above a certain level, the system will deactivate the magnetic lock 21 to allow the door 22 to be opened. The door 22 can be one of several doors used in an access control vestibule, or a single door such as a fire escape which is kept locked and only opened in an emergency. The system can also be used to control operation of things such as escalators. When an earthquake or bomb explosion is detected, the power to the escalator can be shut off to disable the escalator.

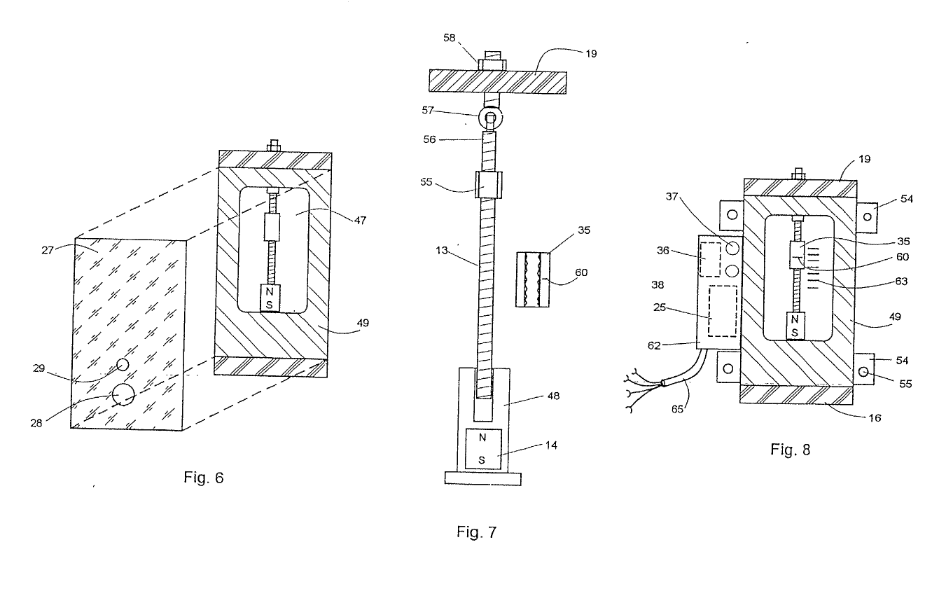

The vibration or seismic sensor 10 is shown in FIG. 6 with a front plate 49 having a cutout portion 47 therein so that the inside contents of the sensor 10 can be easily viewed. A transparent plastic or glass plate 27 is secured to the front plate 49 of the sensor 10, over the cutout portion 47. A small hole 29 in the glass plate 27 is used so that a probe can be inserted such that the magnetic 14 can be displaced to test the system in operation. A large hole 28 is also in the glass plate so that the red light 37 (and the green light 38 if used) can be placed therein. The glass plate 27 preferably has four small holes positioned at each respective corner so that the plate 27 can be secured to the front plate 49 by screws.

The pendulum or bar 13 of the sensor is shown in FIG. 7. The pendulum 13 is a solid piece of stainless steel (the preferred mode) or brass having threads on the outside. A weight 35 with a hole through the axis also has threads to engage the threads on the pendulum 13. The weight 35 can be positioned along the pendulum 13 by rotating the weight. The weight includes a marking 60 thereon (see FIG. 8) and the inside of the box includes a scale 63 marked thereon. The scale 63 is also visible through the opening 47 of the front face 49 of the box. The weight can be accurately adjusted along the pendulum by aligning the marking 60 with the scale 63. A magnet 14 is secured to a plastic holder 48 which is secured to the pendulum 13 by a compound such as epoxy. The top of the pendulum 13 is connected to an eye-bolt 56 by way of a nut 55. The eye-bolt 56 includes threads that can be screwed into the nut 55. Another eyebolt 57 is engaged with the first eye-bolt 56 to form a pivot point for the pendulum 13. The second eye-bolt 57 passes through a hole in the top plate 19. A nut 58 secures the second eye-bolt 57—and thus the pendulum assembly—to the top plate 19. The space or distance between the magnet 14 and the contact switch 15 can be adjusted by adjusting the nut 58 on the second eye-bolt 57.

The preferred embodiment of the seismic sensor 10 is shown in FIG. 8. The metal box used to make the sensor is preferably made of aluminum, and is 2 inches by 2 inches in cross-sectional shape and 10 inches in length. Plastic strips 54 are mounted to the top and bottom ends of the sensor on the back side of the box, and are used to secure the sensor into position. The strips 54 are preferably made of a hard plastic of about ⅜ inch thickness, and have holes 55 to accept mounting screws. Secured to the side of the box is a second box 62 used to contain the buzzer 36 and the relay board 25. A wire cable 65 exits through one hole formed in the bottom of the second box 62, and contains the wires 17 and 18, and two other wires. The second box 62 also includes holes for the red light 37 and green light 38 used to determine the status of the sensor. When the green light is on, the sensor is ready for operation. When the red light is on, the contact switch is in the closed position. When the sensor is operating properly, the green light should be on and the red light should be off when the magnetic 14 is over the contact switch 15. When the special tool is used to displace the magnet 14 so that the contact switch 15 is closed, the green light would turn off and the red light would turn on.

In another embodiment of the invention, the sensor 10 can have the relay switch 25 formed integral with the bottom plate 16. The relay switch is of such size that it can be used as the bottom plate 16. This embodiment would provide for a compact seismic or vibration sensor which includes the relay switch 25. The magnetic contact switch 15 would be mounted on the top of the relay switch 25 such that the contact 15 is positioned near the magnet 14.

In conclusion, it is to be understood that the present invention is not to be limited to that precisely as described herein and as shown in the accompanying drawings. More specifically, the invention could be adapted to provide security for any secure area such as a bank vault, jewelry store, prison, or other security buildings. Further, the entrance chamber as disclosed herein may be employed to control access to the secured area, and other exit-only arrangements may be provided, for example, of the general type used is subway exits using a one-way revolving door type assembly having interlocking bars to prevent entry. Accordingly, the present invention is not limited to the arrangements precisely as shown and described herein.

I claim:

1. A door lock control system, comprising:
a door mounted in a door frame;
a door lock associated with the door to lock and unlock the door;
control means to lock and unlock the door lock; and,
a vibration sensor associated with the control means, the control means causing the door lock to be unlocked when a vibration above a certain level is sensed by the vibration sensor.

2. The door lock control system of claim 1, and further comprising:
the door lock is a magnetic lock.

3. The door lock control system of claim 1, and further comprising:
the vibration sensed by the vibration sensor is an earthquake or a bomb explosion.

4. The door lock control system of claim 1, and further comprising:
the vibration sensor includes a permanent magnetic connected to a pendulum, a magnetic contact positioned near the permanent magnet, and a relay switch.

5. The door lock control system of claim 1, and further comprising:
the control means to lock and unlock the door lock further comprises:
a low voltage DC power source;
a backup battery;
a relay switch; and,
the vibration sensor.

6. The door lock control system of claim 5, and further comprising:
the low voltage DC power source, the backup battery, the relay switch, and the vibration sensor are all contained within a control box.

7. The door lock control system of claim 6, and further comprising:
the control box is mounted at a location remote from small vibrations caused by the door.

8. The door lock control system of claim 6, and further comprising:
the control box is mounted to a rigid wall or column remote from the door.

9. A method of controlling a lock on a door, comprising the steps of:
maintaining a door in a locked state;
monitoring for vibrations near the door;
determining if the monitored vibration is above a certain level; and,
unlocking the door if the vibrations is above the certain level.

10. The method of controlling a lock on a door of claim 9, and further comprising the steps of:
the step of monitoring for vibrations includes monitoring for an earthquake or a bomb explosion.

11. The method of controlling a lock on a door of claim 9, and further comprising the steps of:
the step of determining if the monitored vibration is above a certain level includes the step of determining if the vibration is above 0.1 g.

12. A control box, comprising:
a box;
a door hinged to the box;
a DC power supply mounted in the box;
a backup battery mounted in the box;
a terminal and fuse board mounted in the box; and,
a vibration sensor mounted in the box.

13. The control box of claim 12, and further comprising;
the DC power supply is a low voltage power supply.

14. A vibration sensor, comprising;
a hollow body;
a top plate mounted to a top of the body;
a pendulum attached to the top plate;
a permanent magnet attached to the pendulum;
a bottom plate mounted to a bottom of the body;
a magnetic contact switch mounted to the bottom plate;
a weight displaceable along the pendulum;
a marking on the weight; and,
a scale on the body, the marking and the scale forming a means to determine a position of the weight along the pendulum.

15. The vibration sensor of claim 14, and further comprising:
a second box secured to a side of the body;
a relay switch secured within the second box; and,
a wire to electrically connect the relay switch to the magnetic contact switch.

16. The vibration sensor of claim 15, and further comprising:
the pendulum includes a threaded outer surface, and the weight includes a hole having threads which engage the threads of the pendulum.

17. The vibration sensor of claim 15, and further comprising:
a front plate;
a cutout portion in the front plate;
a transparent plate; and,
the transparent plate having a hole therein and positioned near to the magnet on the pendulum such that a tool can be inserted through the hole to displace the magnet.

18. The vibration sensor of claim 15, and further comprising:
a first eye-bolt connected to the pendulum;
a second eye-bolt connected to the first eye-bolt;
a hole in the top plate; and,
the second eye-bolt being adjustably secured to the top plate through the hole by a nut secured to the second eye-bolt.

19. The vibration sensor of claim 15, and further comprising:
the bottom plate including a relay switch; and,
a plurality of wires extending out from the bottom plate.

20. The vibration sensor of claim 17, and further comprising:
the cutout portion is of such size so as to allow for the position of the weight on the pendulum and a space between the magnet and the contact switch to be observed through the cutout portion; and,
a hole in the transparent plate located near the magnet of the pendulum.

21. The vibration sensor of claim 15, and further comprising:
an opening in the second box; and,
indication means visible through the hole to indicate a status of the sensor.

22. The vibration sensor of claim 21, and further comprising:
the indication means includes a red light and a green light, the green light indicating a ready status of the sensor and the red light indicating a displaced position of the pendulum.

23. The vibration sensor of claim 22, and further comprising:
a buzzer mounted to the second box.

24. The vibration sensor of claim 14, and further comprising:
a relay switch integral with the bottom plate;
a wire to connect the relay switch with the magnetic contact switch; and,
wires extending out from a hole in the bottom plate.
